(19) United States
(12) Patent Application Publication
(10) Pub. No.: US 2015/0060623 A1
(43) Pub. Date: Mar. 5, 2015

(54) Removable Accessory Mount

(71) Applicant: Ronald P. Nigro, Pembroke Pines, FL (US)

(72) Inventor: Ronald P. Nigro, Pembroke Pines, FL (US)

(21) Appl. No.: 14/019,464

(22) Filed: Sep. 5, 2013

(51) Int. Cl. F16M 13/02

(52) U.S. Cl. CPC F16M 13/022; F16M 13/02
USPC 248/309.2; 248/200; 248/309.4

(57) ABSTRACT

A removable accessory mount that includes and outside support on the outside of an item that is secured to an inside support located on an inner surface of the item. The inside and outside supports are secured to one another via a support post that can be a threaded post, a pin, etc. The outer surface of the outside support attaches to accessories that can be removed from the outside support and replaced with other items. Likewise, the accessories can be moved to other accessory mounts. In addition, the accessory mount can also be moved from one item to another without substantial damage due to the small nature of the support post that secures the inside and outside supports together.

### BACKGROUND

1. Technical Field

This invention relates to accessory mounting devices. More particularly, this invention relates to removable accessory mounts that can be relocated from one item to another, and which further contain a variety of attachment surfaces for removably attaching an accessory to the accessory mount.

2. Background of the Invention

Many individuals like to show their support for causes and organizations they favor. For example, sports fans may wish to show their support for their local team. Some may wish to show support for their local community, or a community they have visited on vacation, social issues they believe in, and/or political opinions, etc. One form of showing their support is to use patches with logos, insignias, colors, etc.

Unfortunately, the conventional method of simply sewing a patch on an item, such as a cap, a shirt, a jacket, a backpack, etc. creates a permanent attachment which limits the use of the item to which the patch is attached. For example, an individual may want to use a patch with a football team's logo during football season, and have a different patch during basketball season. The same applies to political issues where an individual might wish to temporarily use a patch that supports. The disadvantage of sewing on a patch is that it is permanent and cannot be changed depending on the needs and wishes of the user. As a result, once an individual, such as a sports fan, sews an insignia on a hat, that that is not very useful for other sports in different sports' seasons. It would be advantageous to have a method of changing the insignia quickly and conveniently without the disadvantages of permanently sewing on a patch.

In addition, there are other items aside from hats or caps to which an individual may want to secure a patch. For example, the individual may wish to secure a patch to a shirt, a jacket, a coat, a backpack, etc. It would be advantageous to have a patch that can be easily relocated from one type of item to another.

Another disadvantage associated with the prior art is that attachment of patches often damages the item that the patch is attached to. It would be desirable to have a method of removably attaching a patch without causing any significant damage to the item it is attached to.

Patches are only one type of item that an individual may wish to attach to an object. In addition to patches, a user may wish to attach any number of useful items to an object such as a cap, a hat, backpack, etc. For example, verse objects, such as printed material, decorative artwork, and even electronic devices could be attached to an object. It would be desirable to have a single type of support structure that could attach any number of useful objects to an item.

An example of another type of item that a user may wish to display is printed material. For example, a sports fan may wish to display an item such as a baseball card, someone at a business meeting may wish to display a business card or a card identifying him by name and/or company, etc. For ease of discussion, the term baseball card shall be used to describe any collectable card related to any sport, and not limited to the game of baseball.

An individual may wish to have a convenient way to attach an item such as an audio video device, and illumination device, such as an LED light, or if not Bluetooth device to allow audio data to the output separate from the Bluetooth transmission device (e.g., iPod™, MP3 player, etc.).

The prior art has failed to provide method of attaching useful items, such as patches printed materials, audio/video devices, Bluetooth devices, illumination devices, and/or other objects such that can be easily removed and transferred to other items with minimal damage to the underlying support structure (e.g., hat, luggage, backpack, etc.).

### SUMMARY OF THE INVENTION

The invention provides an accessory mount that includes an outer support on the outside of an item that is secured to an inner support located on an inner surface of the item. The outer and inner supports are secured to one another via a support post that can be a threaded post, a pin, a magnet, etc. The outer support of the accessory mount attaches to items that can be detached from the outer support and replaced with other items. Likewise, the items can be moved to other accessory mounts. In addition, the accessory mount can be moved from one item to another without substantial damage due to the small nature of the support post that secures the inner and outer supports together.

### BRIEF DESCRIPTION OF THE DRAWINGS

FIG. 1A illustrates a side plan view of the accessory mount that shows the inside support, the outside support, the support post, and hook and loop material extending from the outer surface of the outside support.

FIG. 1B illustrates a surface view of the outer surface of the outside support whose surface is fabricated from hook and loop material.

FIG. 1C illustrates an edge view of a patch that has hook and loop material on one side that secures to the hook and loop material on the outside support.

FIG. 2A illustrates an alternative embodiment of the accessory mount illustrated in FIG. 1A in which an exterior rim is added.

FIG. 2B illustrates a surface view of the outer surface of the outside support whose surface is hook and loop material, and which further has a rim extending around the perimeter of the outside support.

FIG. 2C illustrates an edge view of the patch that has hook and loop material on one side that secures to the hook and loop material on the outside support.

FIG. 3A illustrates another alternative embodiment of the accessory mount illustrated in FIG. 1A. This embodiment uses magnetic surfaces on the outside support and on the patch to secure the patch to the outside support in place of hook and loop material.

FIG. 3B illustrates a surface view of the outer surface of the outside support whose surface is magnetic material.

FIG. 3C illustrates an edge view of a patch that has magnetic material on one side that secures to the magnetic material on the outside support.

FIG. 4A illustrates yet another alternative embodiment of the accessory mount illustrated in FIG. 1A. This embodiment uses adhesive to secure the patch to the outside support.

FIG. 4B illustrates a surface view of the outer surface of the outside support.

FIG. 4C illustrates an edge view of a patch that has adhesive on one side that secures to the outer surface of the outside support.

FIG. 5A illustrates a further alternative embodiment of the accessory mount illustrated in FIG. 1A. In this embodiment, the patch is an integral part of the outside support.

FIG. 5B illustrates a surface view of the sports logo forms the outer surface of the outside support, and is an integral part thereof.

FIG. 6A illustrates a still further alternative embodiment of the accessory mount illustrated in FIG. 1A. In this embodiment, the patch has an irregular shape.

FIG. 6B illustrates a surface view of the outer surface of the outside support.

FIG. 6C illustrates a surface view of the patch that has an irregular shape and is of a different size than the outside support.

FIG. 6D illustrates an edge view of a patch has mounting material that secures to the outer surface of the outside support.

FIG. 7A illustrates yet another alternative embodiment of the accessory mount illustrated in FIG. 1A. In this embodiment, the support post extends from the inside support instead of the outside support.

FIG. 7B illustrates a surface view of a patch having a sports logo that is intended for attachment to the outside support.

FIG. 8A illustrates another alternative embodiment of the accessory mount illustrated in FIG. 6A.

FIG. 8B illustrates a surface view of the outer surface of the outside support.

FIG. 8C illustrates a surface view of the patch. In this embodiment, the patch is a transparent sleeve that is designed to hold insertable printed material. In this example, the sleeve holds a baseball card.

FIG. 8D illustrates an edge view of a patch that has mounting material that secures to the outer surface of the outside support.

FIG. 9A illustrates another alternative embodiment of the accessory mount illustrated in FIG. 1A. In this embodiment, an audio/video device is used.

FIG. 9B illustrates a surface view of an audio/video device.

FIG. 10A illustrates another alternative embodiment of the accessory mount illustrated in FIG. 1A. In this embodiment, a Bluetooth receiver and output device is used.

FIG. 10B illustrates a surface view of the Bluetooth output device.

FIG. 11A illustrates another alternative embodiment of the accessory mount illustrated in FIG. 1A. In this embodiment, a and LED lamp is used as the output device.

FIG. 11B illustrates a surface view of the LED lamp output device.

### DETAILED DESCRIPTION OF THE PREFERRED EMBODIMENT

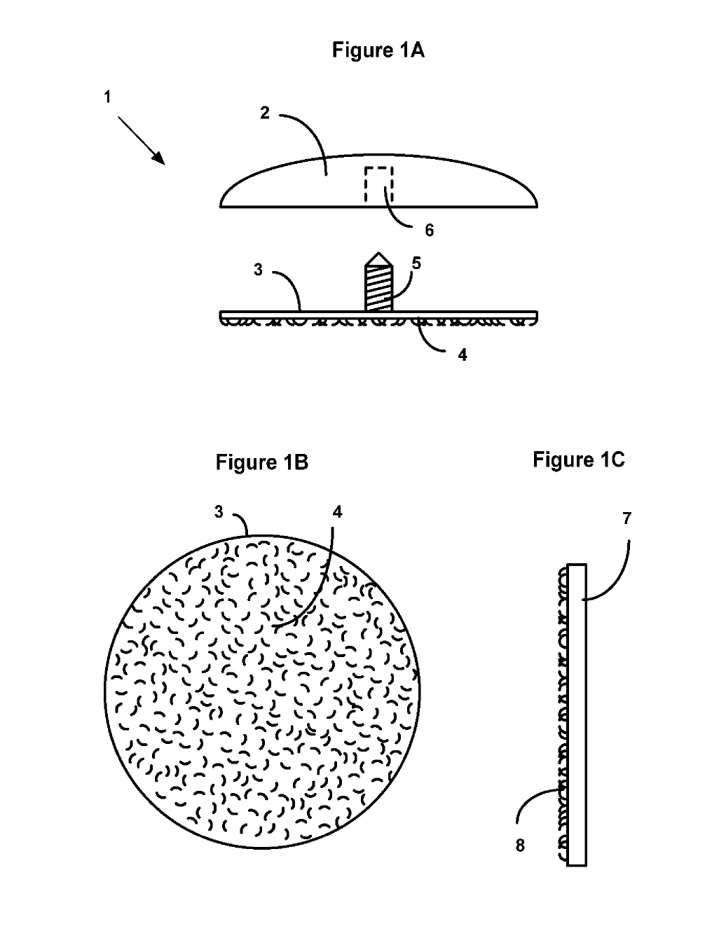

In regard to FIG. 1A, this figure illustrates a side plan view of the accessory mount 1 that shows the inside support 2, the outside support 3, the support post 5, and hook and loop material 4 extending from the outer surface of the outside support 3. Also shown it is the threaded channel 6 that accepts support post 5 when the outside support 3 is secured to the inside support 2. For ease of illustration, the support post 5 is not drawn to scale. Further, those skilled in the art will recognize that while a threaded support post 5 can be used, any suitable attachment method can be used, including pins, clamps, magnetic attachment devices etc. The figure also shows hook and loop material 4 extending from the outer surface of the outside support 3. The layer of hook and material 4 on the outside support 3 can be conventional hook and loop material, or it can be molded as part of the outside support 3.

When an individual desires to attach a removable item to a garment, backpack, etc., the support post 5 is pressed through the garment, backpack, etc., and secured to the inside support 2. In practice, the support post 5 would be very narrow whether it is a threaded post or a pin. By using a very narrow support post 5, only minimum damage will be done to the item. Once the accessory mount 1 is secured to the garment, backpack, etc., a patch 7 (or other item) can be secured to the accessory mount 1. When the user decides to change the patch 7 or other item, the patch 7 is merely peeled off and replaced with a new patch 7. Likewise, the accessory mount 1 can be removed altogether.

FIG. 1B shows a surface view of the outer surface of the outside support 3 whose surface is hook and loop material 4. As mentioned above, the hook and loop material 4 can be a conventional piece of hook and loop material that is commonly marketed as Velcro™. However, those skilled in the art will recognize that the outside support 3 can be molded such that the hook and loop material 4 is an integral part of the outside support 3.

FIG. 1C illustrates an edge view of the patch 7 that has hook and loop material 8 on one side that secures to the hook and loop material 4 on the outside support 3.

As can be seen, once the accessory mount 1 is secured, a variety of patches 7 (or other items) can be quickly and easily substituted for one another depending on the needs of the user.

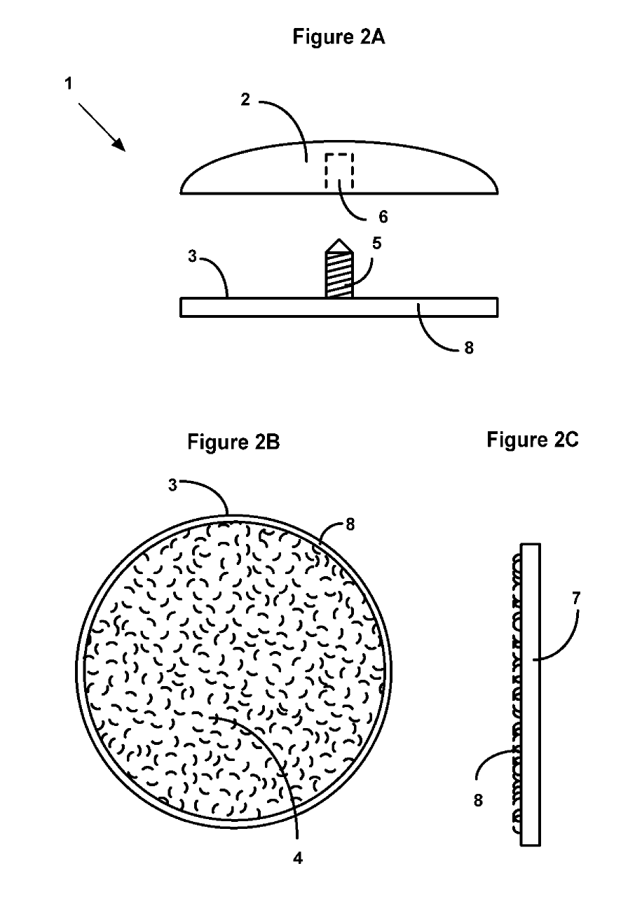

FIG. 2A illustrates an alternative embodiment of the accessory mount 1, illustrated in FIG. 1A, in which an exterior rim 8 is added. The rim 8 provides a neater appearance, and also makes it easier to align the patch 7 with the edge of the outside support 3.

FIG. 2B illustrates a surface view of the outer surface of the outside support 3 whose surface is hook and loop material 4, and which further has a rim 8 extending around the perimeter of the outside support 3.

FIG. 2C illustrates an edge view of the patch 7 that has hook and loop material 8 on one side that secures to the hook and loop material 4 on the outside support 3. In this embodiment, the hook and loop material 8 does not extend to the edge of the patch 7 such that it does not interfere with contact between the patch 7 and the rim 8. Those skilled in the art will recognize that the patch 7 can alternatively be sized such that it fits within the rim 8. In that case, the hook and loop material 8 would extend to the edge of the patch 7.

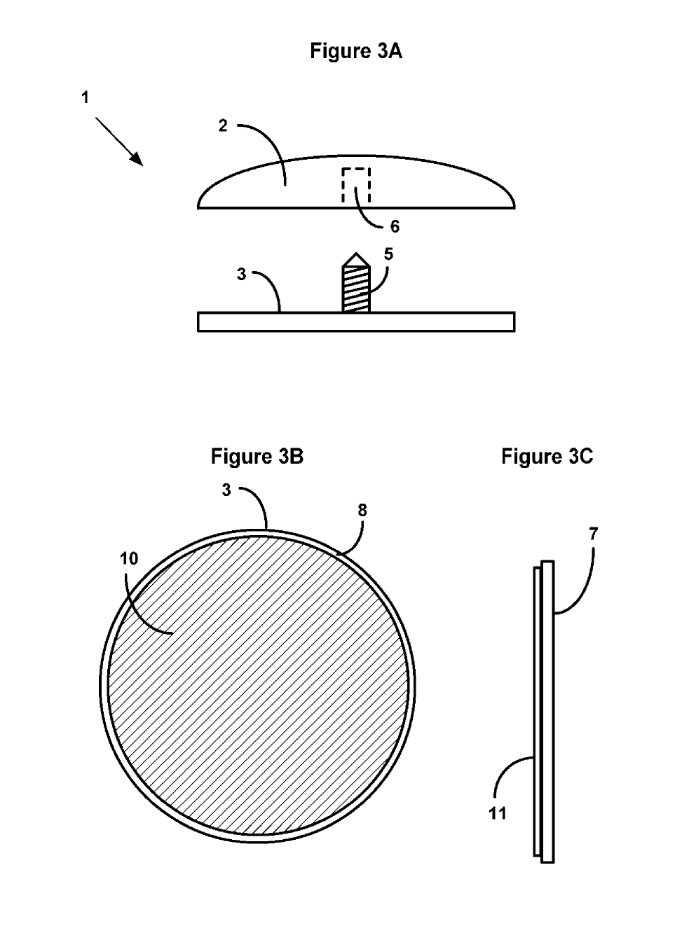

FIG. 3A illustrates another alternative embodiment of the accessory mount 1 illustrated in FIG. 1A. This embodiment uses magnetic surfaces 10-11 on the outside support 3 and on the patch 7 to secure the patch 7 to the outside support 3 in place of hook and loop material 4, 8.

FIG. 3B illustrates a surface view of the outer surface of the outside support 3 whose surface is magnetic material 10. Any magnetic material that is suitable for the purpose of this invention can be used.

FIG. 3C illustrates an edge view of a patch 7 that has magnetic material 11 on one side left secures to the magnetic material 10 on the outside support 3.

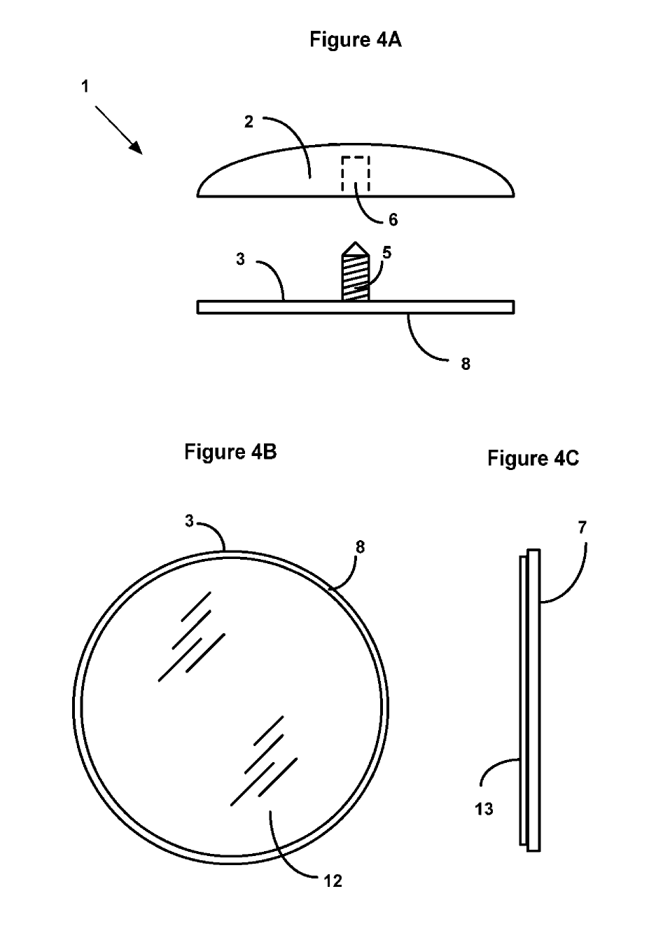

FIG. 4A illustrates yet another alternative embodiment of the accessory mount 1 illustrated in FIG. 1A. This embodiment uses adhesive 13 to secure the patch 7 to the outer surface 12 of the outside support 3.

FIG. 4B illustrates a surface view of the mounting surface 12 of the outside support 3.

FIG. 4C illustrates an edge view of a patch 7 that has adhesive 13 on one side that secures to the outer surface 12 of the outside support 3. Those skilled in the art will recognize that adhesive layer 13 can be located on the patch 7, or on the outer surface 12. Likewise, any adhesive 13 that is suitable for the purpose at hand can be used.

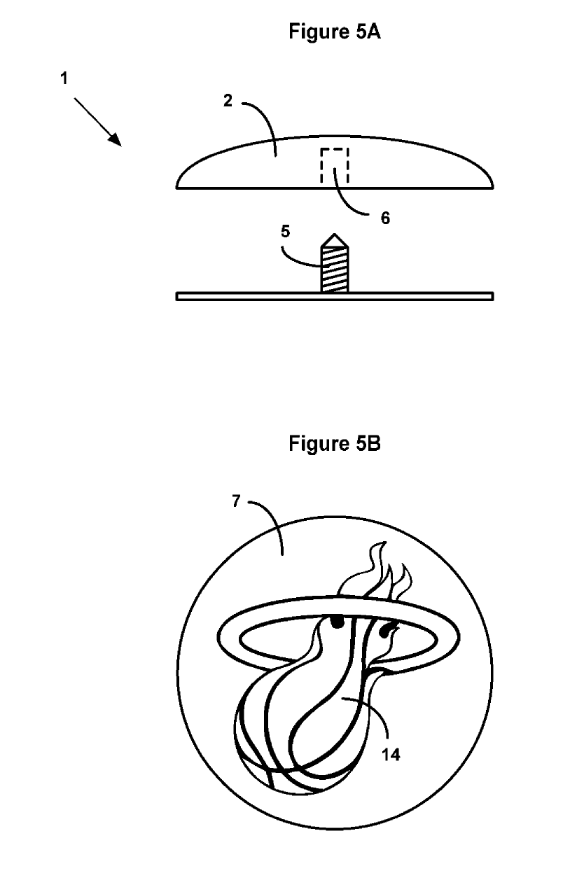

FIG. 5A illustrates a further alternative embodiment of the accessory mount 1 illustrated in FIG. 1A. In this embodiment, the patch 7 is an integral part of the outside support 3. A user may have multiple patches 7 that have preselected indicia or logos of some kind In practice, the user would merely remove the outside support 3 with one type of indicia, and replace it with a substitute outside support 3 that has a different logo or indicia.

FIG. 5B illustrates a surface view of a sports logo 14 that is an integral part of, and forms the outside surface of, the outside support 3. Those skilled in the art will recognize that the sports logo 14 can be fabricated from any suitable material, such as fabric, ceramics, wood, metal, etc.

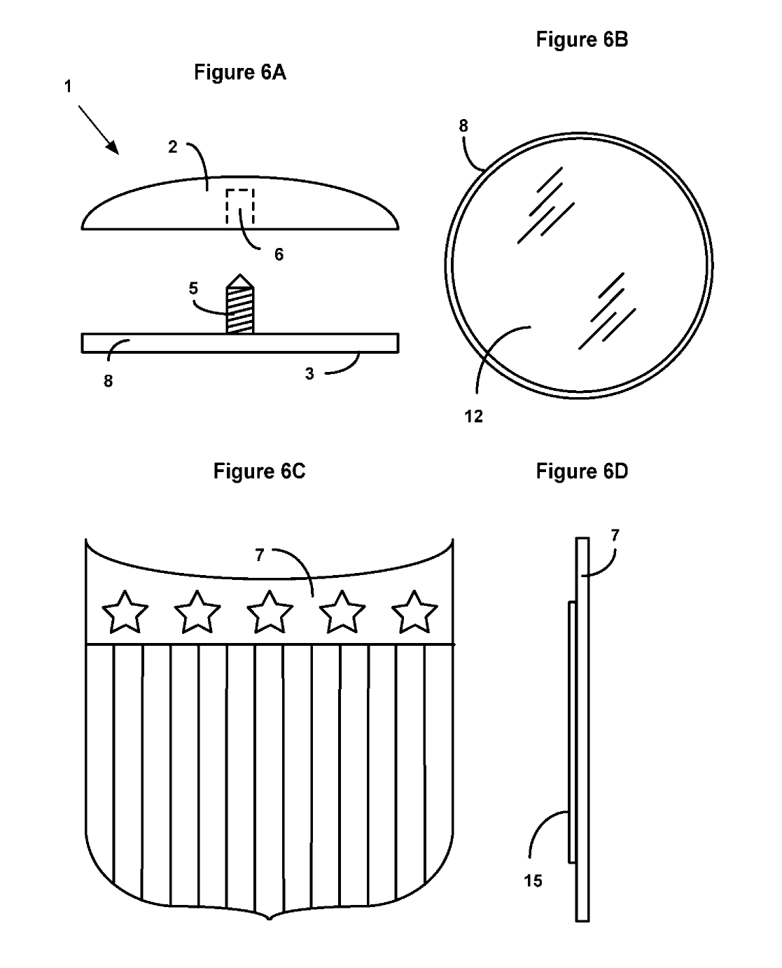

FIG. 6A illustrates a still further alternative embodiment of the accessory mount 1 illustrated in FIG. 1A. In this embodiment, the patch 7 has an irregular shape. In addition, it can be a different size and shape than the outside support 3, and is illustrated that way.

FIG. 6B illustrates a surface view of the outer surface 12 of the outside support 3. In this and the preceding embodiments, the outside support 3 has been illustrated as a circular platform. This was done for convenience, but those skilled in the art will recognize that patch support 3 can take any desired shape. Likewise, any of the embodiments can be implemented with or without the rim 8. Still further, the outside support 3 can be shaped in the same configuration as the item it is attached to, or it can keep a standard shape, such as the circle illustrated.

FIG. 6C illustrates a surface view of the patch 7 that has an irregular shape and is of a different size than the patch support 3 shown in FIG. 6B.

FIG. 6D illustrates an edge view of a patch 7 has mounting material 15 that secures to the mounting surface 12 of the patch support 3. Mounting material 15 can be any material suitable for securing the patch 7 the patch support 3, such as hook and loop material 4, 8, adhesive 13, magnetic material 10-11, etc. As indicated in this figure, the mounting material 15 would be sized to fit the outer surface 12 of the outside support 3.

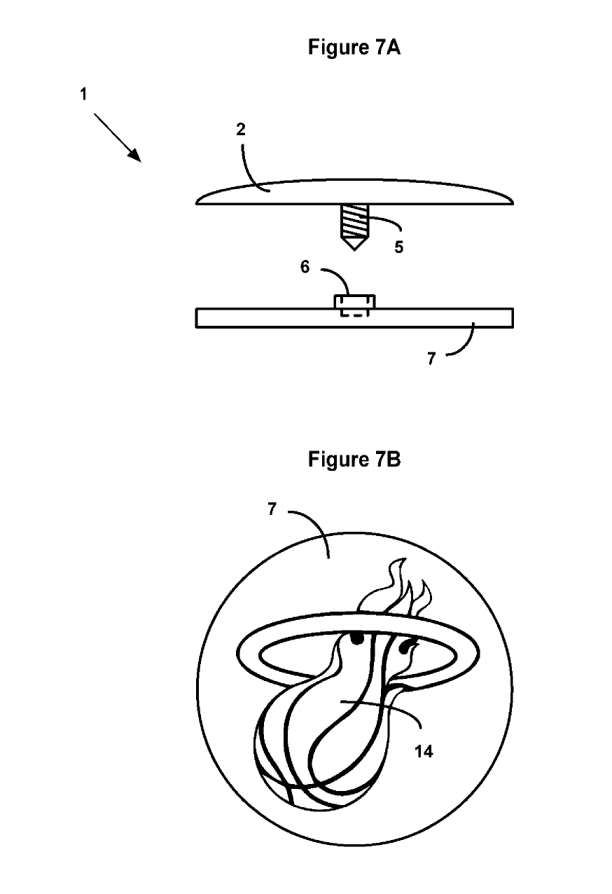

FIG. 7A illustrates yet another alternative embodiment of the accessory mount 1 illustrated in FIG. 1A. In this embodiment, the support post 5 extends from the inside support 2 instead of the outside support 3.

FIG. 7B illustrates a surface view of a patch 7, having a sports logo 14.

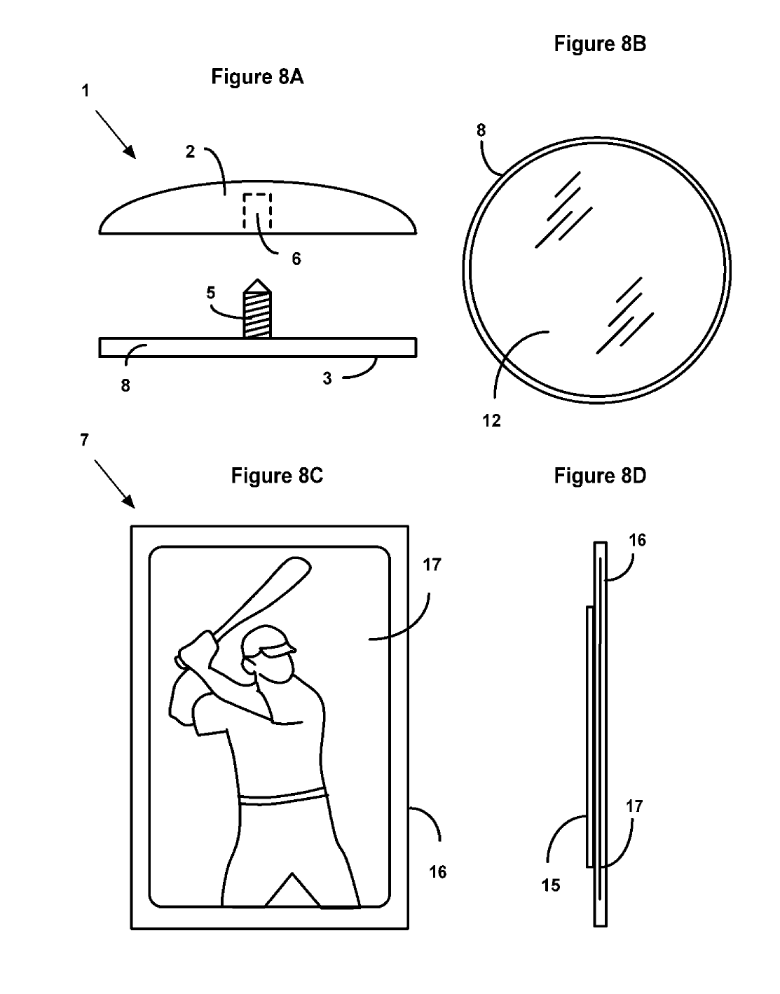

In regard to FIG. 8A, this figure illustrates a variation of the embodiment of the accessory mount 1 illustrated in FIG. 6A. In this embodiment, that patch 7 is replaced by a transparent sleeve 16 (shown in FIG. 8C) that holds printed material 17 (shown in FIG. 8C).

FIG. 8B illustrates a surface view of the outer surface of the outside support 3. The outside support functions in the same manner as the patch support 3 in FIGS. 6A-D.

FIG. 8C illustrates a surface view of the patch 7. In this embodiment, the patch 7 is a transparent sleeve 16 that is designed to hold insertable printed material 17. In this example, the insertable printed material 16 is a baseball card.

FIG. 8D illustrates an edge view of a patch 7 that has mounting material 15 that secures to the outer surface 12 of the outside support 3.

Those skilled in the art will recognize that the attachment of the patch 7 to the outside support 3 in the various embodiments is interchangeable. Any suitable means, such as hook and loop, adhesive, magnets, etc., can be used.

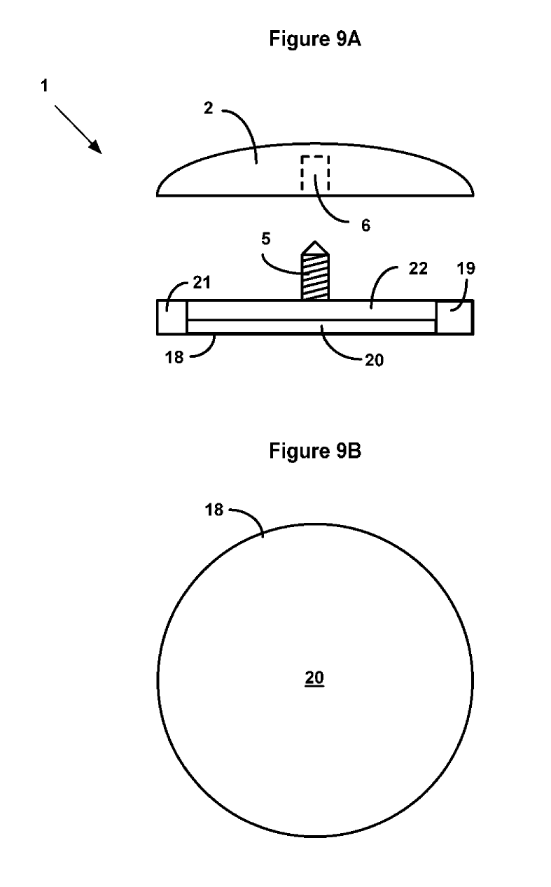

FIG. 9A illustrates another alternative embodiment of the accessory mount 1 illustrated in FIG. 1A. In this embodiment, the accessory is an audio/video device 18. The audio/video device 18 secures to the outside support 3 in the same manner as the other embodiments. Audio/video device 18 incorporates a video display 20, an audio speaker 21, a power source 19, and a control unit 22. The control unit includes storage for video and/or audio data that is displayed on the video display 20 and/or output via audio speaker 21. The audio/video device 18 can be preprogrammed or have the capability of updating or modifying the audio/video data on a dynamic basis through known techniques. This allows the user to display any message they desire in an entertaining manner.

FIG. 9B illustrates a surface view of the audio/video patch 18 and shows the display 20. The audio speaker 21 can optionally be placed on the surface or on the side of the audio/video patch 18.

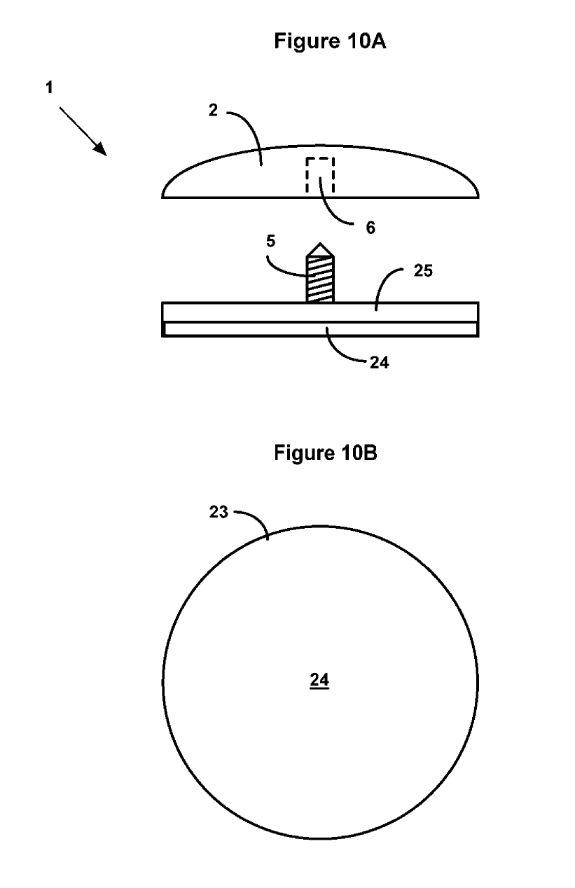

FIG. 10A illustrates another alternative embodiment of the accessory mount 1 illustrated in FIG. 1A. In this embodiment, the accessory is a Bluetooth audio device 23. The Bluetooth audio device 23 secures to the outside support 3 in the same manner as the other embodiments. Bluetooth audio device 23 incorporates an audio speaker 24, and a receiver 25. The receiver 25 includes a power supply, and an on/off switch that were omitted from the drawing for ease of illustration. The Bluetooth audio device 23 can play audio data on a dynamic basis through known techniques using a variety of Bluetooth capable devices (e.g., iPod™, Smart phone, MP3 device, etc.) as a music data source. This allows the user to play a wide variety of music of their choice.

FIG. 10B illustrates a surface view of the Bluetooth audio device 23 and shows the audio speaker 24. The audio speaker 24 can optionally be placed on the surface or on the side of the Bluetooth audio device 23.

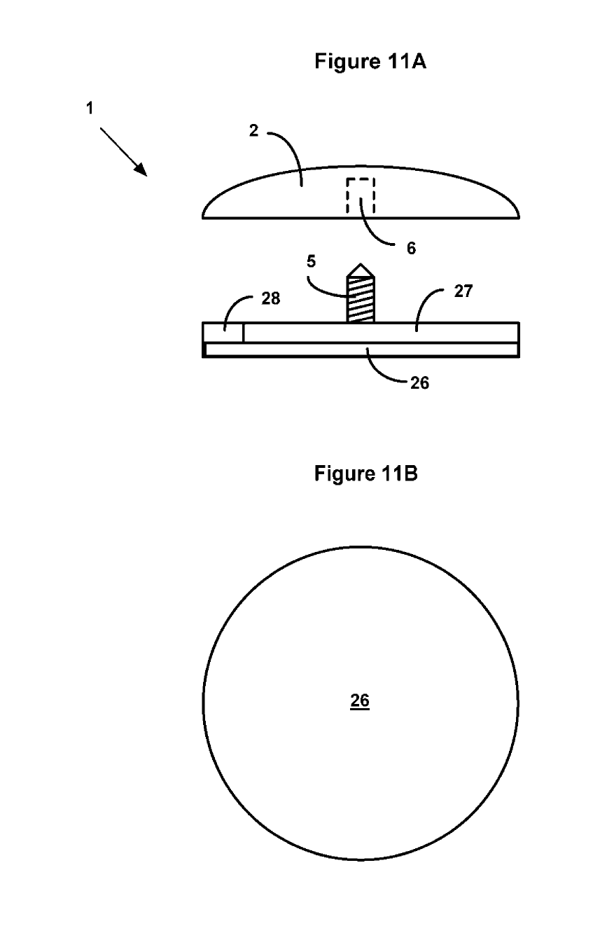

FIG. 11A illustrates another alternative embodiment of the accessory mount 1 illustrated in FIG. 1A. In this embodiment, the accessory is an LED lamp. This embodiment allows the user to convert a conventional hat into a hat with an integral light to aid when working in dark environments.

FIG. 11B illustrates a surface view of the LED lamp 26.

While the present invention has been described in its preferred form in terms of certain embodiments with a certain degree of particularity, alterations and permutations of these embodiments will be apparent to those skilled in the art. Accordingly, its understood that the above descriptions of exemplary embodiments does not define or constrain this disclosure, and that the present disclosure of the preferred form has been made only by way of example and that numerous changes, substitutions, and alterations in the details of construction and the combination and arrangement of parts may be resorted to without departing from the spirit and scope of the invention.

I claim:

1. An accessory mounting device, comprising:
an accessory support having an inside support for placement on the inside surface of an item and an outside support for placement on the outside surface of the item;
the outside support having attachment means to secure an object to the outside support; and
connection means to secure the inside support to the outside support.

2. A device, as in claim 1, wherein the connection means further comprises a support post that extends from the inside support through the item and secures to the outside support such that the inside support and outside support are securely attached to the item.

3. A device, as in claim 1, wherein the connection means further comprises a support post that extends from the outside support through the item and secures to the inside support such that the inside support and outside support are securely attached to the item.

4. A device, as in claim 1, wherein the connection means further comprises a first magnet on the inside support and a second magnet on the outside support that secure the inside support and the outside support together such that the inside support and outside support are securely attached to the item.

5. A device, as in claim 1, wherein the object comprises a patch.

6. A device, as in claim 1, further comprising a rim that extends around the periphery of the outside support and defines an area inside the rim and is sized to accept the object.

7. A device, as in claim 1, wherein the outside support has the same size and shape as the object.

8. A device, as in claim 1, wherein the outside support has a different size and shape as the object.

9. A device, as in claim 1, wherein the object is a transparent sleeve.

10. A device, as in claim 1, wherein the transparent sleeve is sized to hold printed material.

11. A device, as in claim 1, wherein the transparent sleeve is sized to hold a baseball card.

12. A device, as in claim 1, wherein the outside support further comprises an integral logo or image on its outer surface.

13. A device, as in claim 1, wherein the outside support further comprises a lamp.

14. A device, as in claim 13, wherein the lamp is an LED lamp.

15. A device, as in claim 1, further comprising:
a Bluetooth receiver for receiving music from an external Bluetooth music source; and
a speaker for outputting the music received by the Bluetooth receiver.

16. A device, as in claim 1, further comprising:
storage for storing A/V data; and
an A/V output for outputting A/V data.

17. A device, as in claim 1, wherein the attachment means to secure an object to the outside support is hook and loop material.

18. A device, as in claim 17, wherein the hook and loop material on the outside support is an integral part of the outside support.

19. A device, as in claim 1, wherein the attachment means to secure an object to the outside support is magnetic material.

20. A device, as in claim 1, wherein the attachment means to secure an object to the outside support is adhesive.
